(19) United States
(12) Patent Application Publication
(10) Pub. No.: US 2018/0089880 A1
(43) Pub. Date: Mar. 29, 2018

(54) TRANSMISSION OF AVATAR DATA

(71) Applicant: Apple Inc., Cupertino, CA (US)

(72) Inventors: Christopher M. Garrido, San Jose, CA (US); Brian Amberg, Zurich (CH); David L. Biderman, Los Gatos, CA (US); Eric L. Chien, Santa Clara, CA (US); Haitao Guo, Cupertino, CA (US); Sarah Amsellem, Zurich (CH); Thibaut Weise, Menlo Park, CA (US); Timothy L. Bienz, Cupertino, CA (US)

(21) Appl. No.: 15/712,683

(22) Filed: Sep. 22, 2017

Related U.S. Application Data
(60) Provisional application No. 62/399,241, filed on Sep. 23, 2016.

(51) Int. Cl. G06T 13/80; H04N 7/14; H04N 7/15; H04L 29/06

(52) U.S. Cl. CPC G06T 13/80; H04L 65/601; H04N 7/15; H04N 7/147

(57) ABSTRACT

In an embodiment a method of online video communication is disclosed. An online video communication is established between a source device and a receiving device. The source device captures a live video recording of a sending user. The captured recording is analyzed to identify one or more characteristics of the sending user. The source device then generates avatar data corresponding to the identified characteristics. The avatar data is categorized into a plurality of groups, wherein a first group of the at least two groups comprises avatar data that is more unique to the sending user. Finally, at least the first group of the plurality of groups is transmitted to the receiving device. The transmitted first group of avatar data defines, at least in part, how to animate an avatar that mimics the sending user's one or more physical characteristics.

### PRIORITY

This application claims the benefit of U.S. Provisional Application No. 62/399,241; filed Sep. 23, 2016; and entitled TRANSMISSION OF AVATAR DATA; the entire contents of which are incorporated herein by reference.

### BACKGROUND

The inventions disclosed herein relate to the field of online communication, and more specifically, avatar based communication of visual and audio information.

Real-time online communication through smart-phone, tablet, or computer applications have become an integral part of many users' lives. Early on, instant messaging applications were used primarily to communicate text messages between users. As access to high-speed internet expanded, the instant messaging applications were also used to transmit images, Graphics Interchange Formats (GIFs), user locations, audio/videos files, and etc. Now, video messaging applications are commonly used for making video calls in real-time between multiple platforms.

In a typical video messaging communication, a significant amount of internet bandwidth is used to facilitate data transfer between communicating devices. The amount of required bandwidth depends on the quality of the video and audio as well as other factors such as the method of encoding the video content. However, access to connection with a higher bandwidth is not always possible. In such circumstances, a drop in available bandwidth may result in loss of connection. Therefore, it is desirable to develop a video communication system that requires transmission of less data.

### SUMMARY

In one aspect of the disclosure a method of online video communication is disclosed. An online video communication is established between a source device and a receiving device. The source device captures a live video recording of a sending user. The captured recording is analyzed to identify one or more characteristics of the sending user. The source device then generates avatar data corresponding to the identified characteristics. The avatar data is categorized into a plurality of groups, wherein a first group of the at least two groups comprises avatar data that is more unique to the sending user. Finally, at least the first group of the plurality of groups is transmitted to the receiving device. The transmitted first group of avatar data defines, at least in part, how to animate an avatar that mimics the sending user's one or more physical characteristics.

In yet another aspect, another method of online video communication is disclosed. An online video communication is established between a source device and a receiving device. The avatar data corresponding to one or more characteristics of the sending user is received. The avatar data includes modeling information. The modeling information, which describes facial features of the sending user, is used to generate a user model. The receiving device receives an avatar selection. The user model is then applied to the selected avatar such that the avatar is customized to resemble the facial features of the sending user. The modified avatar is then displayed. In another embodiment, the method may be implemented in an electronic device having a display.

### BRIEF DESCRIPTION OF THE DRAWINGS

FIG. 1 is a block diagram of an illustrative video communication system in accordance with one embodiment.

FIG. 2 illustrates a process of obtaining avatar data based on an analysis of a captured video in accordance with one embodiment.

FIG. 3 is a flowchart that illustrates an exemplary data transmission management in accordance with one embodiment.

FIG. 4 illustrates a process of animating avatar elements to track facial features of the sending user in accordance with one embodiment.

FIG. 5 is a flowchart that illustrates the operation of the receiving device in identifying and storing routine behavioral events in accordance with one embodiment.

FIG. 6 is a flowchart that illustrates the operation of the receiving device in displaying the animated avatar in accordance with one embodiment.

FIG. 7 is a simplified functional block diagram of a smart phone capable of performing the disclosed selective render mode operations in accordance with one embodiment.

FIG. 8 is a simplified functional block diagram of a computing system capable of performing the disclosed selective render mode operations in accordance with one embodiment.

### DETAILED DESCRIPTION

This disclosure pertains to systems, methods, and computer readable media for avatar based video communication between multiple online users. In general, the source device transmits avatar data describing the characteristics of the sending user to the receiving device in real-time. The avatar data may then be provisioned as an avatar at the receiving end to mimic the sending user's characteristics. The avatar data may be transmitted in addition to video feed, or alternatively, the communication of the avatar data may replace the transmission of the video feed.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a computer system” can refer to a single computer system or a plurality of computer systems working together to perform the function described as being performed on or by a computer system. Similarly, a machine-readable medium can refer to a single physical medium or a plurality of media that may together contain the indicated information stored thereon. A processor can refer to a single processing element or a plurality of processing elements, implemented either on a single chip or on multiple processing chips.

It will be appreciated that in the development of any actual implementation (as in any development project), numerous decisions must be made to achieve the developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of systems having the benefit of this disclosure and being of ordinary skill in the design and implementation of computing systems and/or graphics systems.

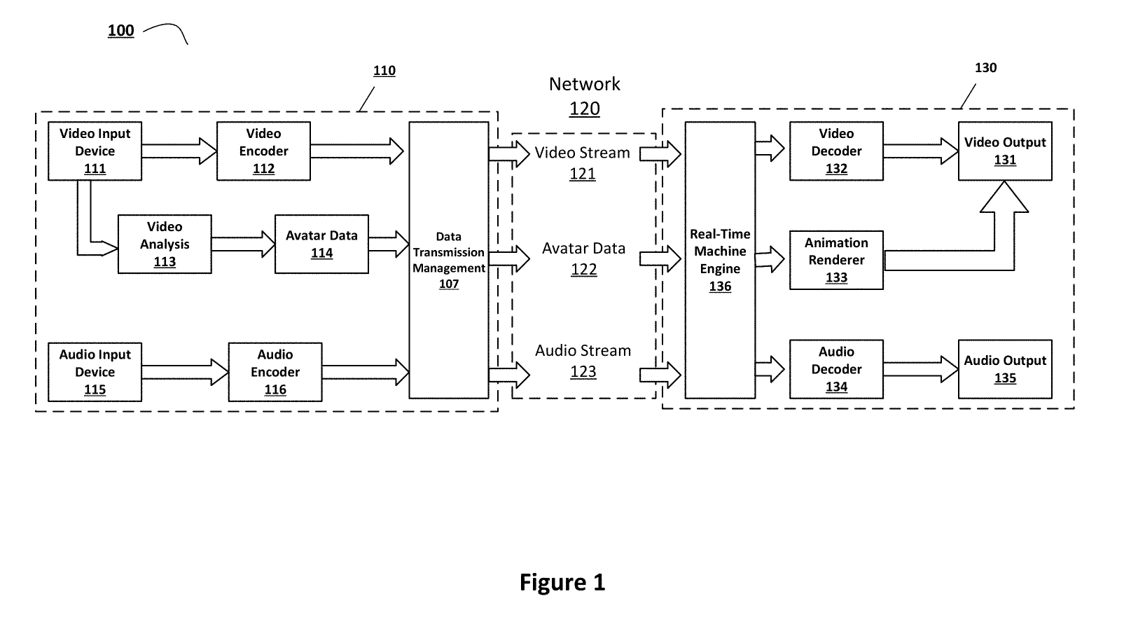

Referring to FIG. 1, a video communication system 100 according to one embodiment is disclosed. The video communication system 100 includes a source device 110, a network 120, and a receiving device 130. The source device 110 may be used by a sending user to record and transmit a video communication through the network 120 to the receiving device 130 in order to be viewed by a receiving user.

In on aspect, the source device 110 may be a smartphone, tablet, personal computer, or any other electronic device capable of forming a video communication with the receiving device 130. In one or more embodiments, the source device 110 may include multiple devices that include the identified components and are communicably connected. In an embodiment, a video input device 111 and an audio input device 115 are used to capture a live audio and video recording of the sending user. For example, the sending user could use the camera and microphone on a smartphone to capture a live video recording. The captured audio may then be transmitted to an audio encoder 116 and the captured video may be transmitted to video encoder 112 before being transmitted through the network 120 to the receiving device 130. The encoders may convert the raw audio and video files to a compressed version in a predetermined format.

In an embodiment, the video content may also be transmitted to a video analysis unit 113 to perform the necessary examinations in order to generate the avatar data. The video analysis unit 113 analyzes the video to gather the avatar data representing motion, depth, and other characteristics such as the facial structure of the sending user captured in the video. The avatar data may also keep track of the changes (e.g. movements) of those characteristics in real-time. In one embodiment, the video analysis includes identifying facial landmarks of the sending user, identifying their characteristics (e.g. size and shape), measuring the relative distance between different components, detecting their movement, and determining changes of these characteristics in real-time. In an embodiment, the analysis may not be limited to the face and can also encompass characteristics and movements of the entire body.

After analyzing the video, the data may be packaged, encrypted and compressed by the avatar data unit 114 before being transmitted to the receiving device 130. In an embodiment, the avatar data unit 114 may send two-dimensional (2D) information plus depth data. In an alternative embodiment, the video analysis to generate avatar data is performed on the receiving device. In such an embodiment, the video stream is received from the source device and transmitted to an avatar data unit on the receiving end. The avatar data unit on the receiving end performs similar operations described below with respect to avatar unit 114 in order to generate avatar data. Subsequently, avatar data is used to create a user model and track user's activity.

In one aspect, the avatar data may include information associated with multiple features of the face or body detected by the video analysis unit 113. For every frame, the avatar data unit 114 may track the changes in the selected features. The features may also be combined or bundled together before being transmitted. In an embodiment, the avatar data unit 114 may quantify the current state of the selected features and communication that information in a floating-point format to the receiving device 130. For example, there may be a floating-point data associated with each of the selected features in order to describe the changes to the corresponding facial landmark. In another example, the floating-point data associated with the right eye could indicate when the eye is closed or opened. In an embodiment, a float may be 4 bytes of data representing features of the face with a detailed precision. A float is a real number, typically in a limited range i.e. between zero and one, which gives the value for one animation channel, such as how strongly the left smile muscle is activated. Real numbers are encoded as “floating-point numbers” in computers, and colloquially referred to as “floats”.

The data transmission management (DTM) unit 107 manages transmission of data from the source device 110 to the receiving device 130. In an embodiment, the DTM unit 107 may transmit the avatar data 122 in addition to the video stream 121 and the audio stream 123. In alternative embodiments, the communication of the avatar data 122 may replace the communication of the video stream 121. In an embodiment, the DTM unit 107 may categorize the received avatar data based on their importance and priority. Subsequently, the DTM unit 107 can decide which data to send to the receiving device based on its priority and factors such as the availability of resources (e.g. bandwidth) and user configurations.

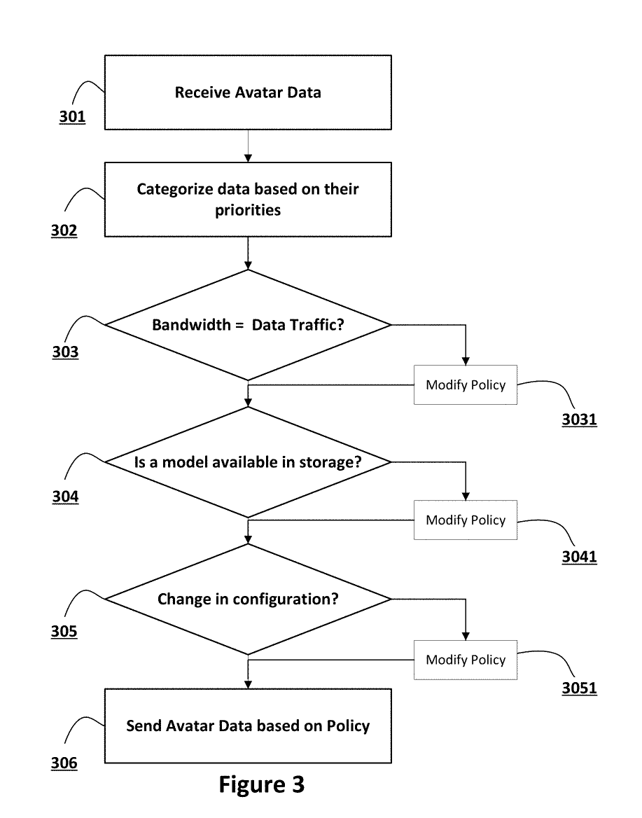

In an embodiment, the DTM unit 107 may communicate its priority to the other units of the source device 110 before the data is processed by those units, and therefore, reducing the processing time as well. To determine its priority, the DTM unit 107 may receive information from the receiving device 130. For example, the receiving device may communicate which information is already available and does not need to be sent again. Referring to FIG. 3, a more detail explanation of the DTM unit 107 is presented.

The data generated by the source device 110 is communicated to the receiving device 130 through the network 120. The network 120 could be any appropriate communication network that is capable of delivering the data generated by the source device 110 to the receiving device 130. For example, the network 120 could be a Wireless Access Protocol (WAP), Bluetooth specification, Global System for Mobile Communications (GSM), G3 or G4 technology. In an embodiment, the network 120 is connected to the internet. In an embodiment, Voice over IP (VoIP) protocol is used to transmit the generated data.

In one embodiment, the video stream 121, the avatar data 122, and the audio stream 123 may be transmitted through the network 120 to the receiving device 130. In another embodiment, only the avatar data 122 and the audio stream 123 may be sent. In an embodiment where the avatar data is generated on the receiving end, only transmission of the video stream 121 and audio stream 123 may be required. In still another embodiment, the video communication may begin with displaying the video stream 121 but when the conditions are not good for the display of video stream, the system may switch to only sending the avatar data 122. For example, the network bandwidth may initially be sufficient for a video steam. However, the network bandwidth may be dropped during the communication, and therefore, the system stops transmitting the video stream 121 and instead it only sends the avatar data 122 and the audio streams 123. The avatar data 122 may include real-time features and movement of the sending user transmitted through the network 120 for rendering on the receiver device 130. The avatar stream is real-time data (RTP) which would allow for an audio-video synchronization on the receiving end.

In an embodiment, the data receiving management (DRM) unit 136 includes an interface to receive and route the transmitted data to the proper unit of the receiving device 130 for further processing. In an embodiment, the DRM unit 136 regularly communicates with the source device 110 regarding the types of data it may or may not require. For example, immediately after a connection is established, modeling information may be prioritized in order to create a user model of the sending user's appearance on the receiving device 130. In other embodiment, the user model is created on the source device and upon establishing a connection the user model is communicated to the receiving device. Whether the use model is created on the receiving end or the sending end, similar operations described below may be adopted.

To create the model, shape prediction methods are used to localize certain facial structure of the sending user (e.g. the features that are more important to describing the sending user's face). This process includes modeling the shapes, size, relative distance, and depth of different elements of the sending user in a mask. Then the mask is applied to an avatar to customize the avatar's appearance in order to mimic the sending user's appearance. Upon creation the sending user's model, tracking information describing the movement and changes of the characteristics are communicated to the receiving device 130.

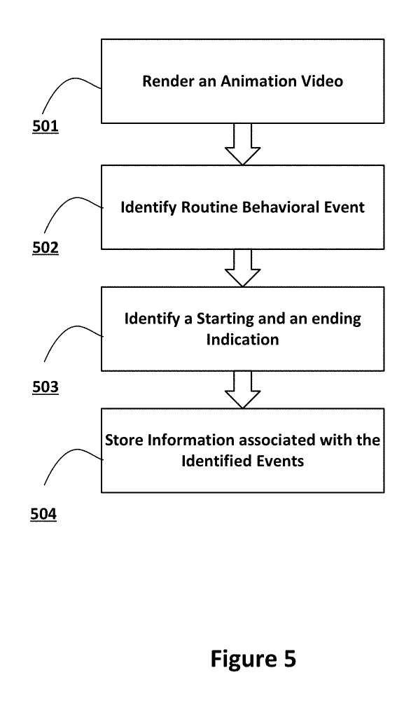

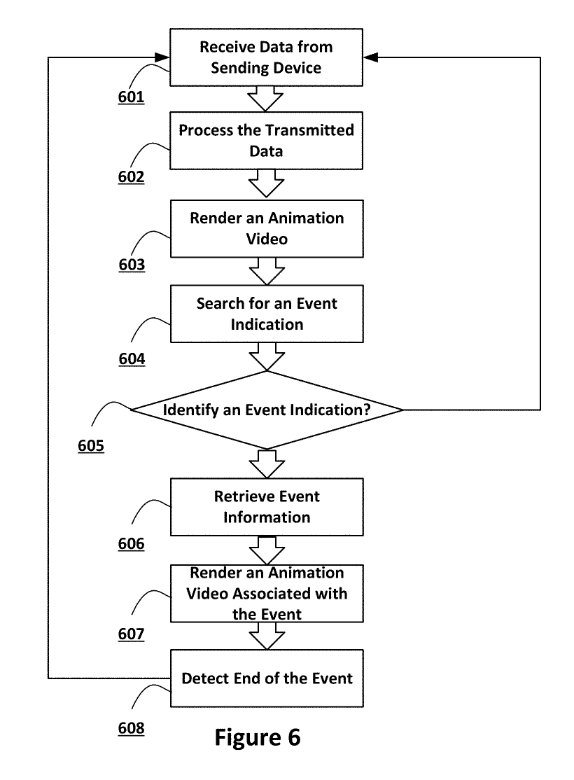

In an embodiment, the user model created for a particular sending user during a communication session may be stored in the receiving device's memory. Upon identifying the sending user (e.g. through a telephone number or facial recognition techniques), the memory may be accessed and the model may be retrieved to reduce transmission of redundant information from the source device 110. The receiving device's operation are discussed in more detail with reference to FIGS. 5 and 6 below.

The video stream 121 is decoded by the video decoder unit 132, the avatar data 122 is decoded by animation render unit 133, and audio is decoded by the audio decoder unit 134. The audio is then synchronized with avatar animation and/or video stream. In one embodiment, the synchronization of the video and audio may be done using time-stamps, i.e. both datasets are time-stamped and then aligned again on the receiving side. Finally, the video output unit 131 is used to display the video and the audio output unit 135 is used to reproduce the sound.

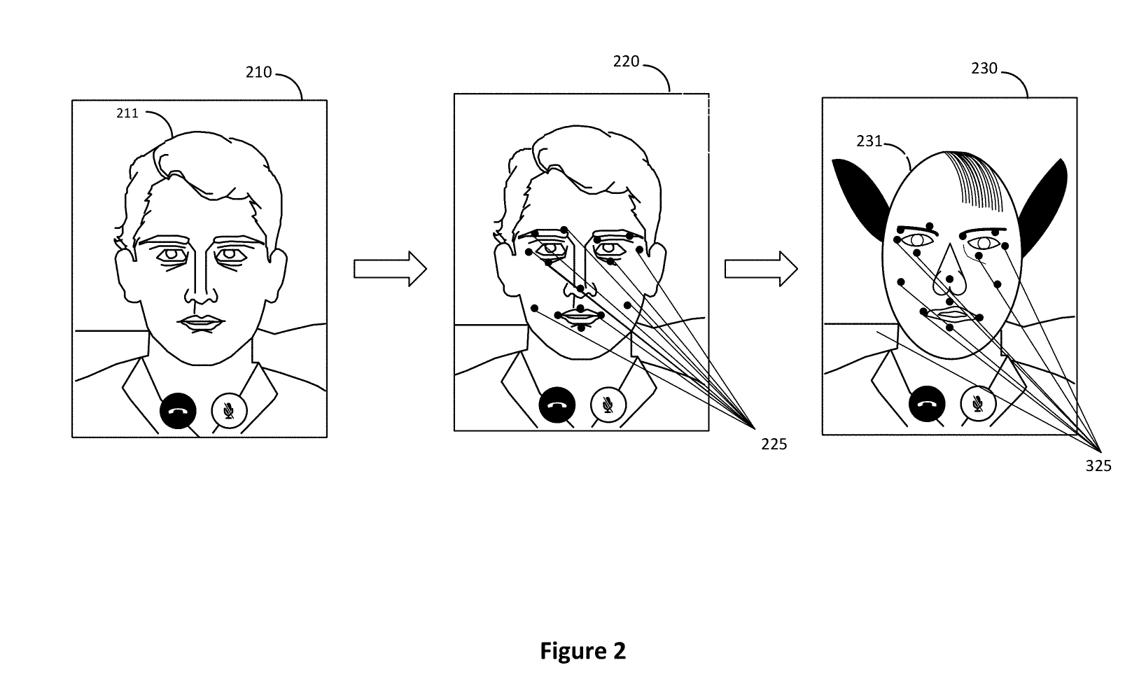

Referring to FIG. 2, the process of obtaining avatar data based on an analysis of a captured video is described. The block 210 represents an exemplary frame of a live video footage captured by a sending user 211. In an embodiment, the captured video may also be displayed through an interface of the source device 110. In an example, the source device 110 may display the generated avatar animation in a preview format.

In an embodiment, the sending user 211 may select a choice of avatar that the captured video is rendered on. As a result, the source device receives a selection of a choice of avatar from the sending user 211. In other embodiments, the sending user 211 may select to keep a portion of the original video but modify the other parts. For example, the sending user 211 may make a selection of a virtual clothes to be displayed instead of his/her original clothing. Other selections may include, but not limited to, hairstyle, skin tones, beard/moustache, glasses, hats, and etc. In yet another embodiment, the choice of avatar may be communicated by the receiving user. In an embodiment, the avatar may be selected from categories such as animal avatars, cartoon characters, or other virtual creatures.

The block 220 displays the real-time video analysis stage by the source device in order to generate avatar data. The video analysis may consist of at least two operations: first, to identify the defining characteristics of the sending user 211 in order to create a user model. Second, to track motions and changes in those characteristics. Tracking information is used to mimic the expressions, movements, and gestures of the sending user 211 by the animated avatar 231 at block 230.

In one embodiment, the sending user's identification phase is performed prior to the tracking operation. In such an embodiment, prior to establishing a communication with another device, a training session is used to identify the feature characteristics of the sending user 211 on the source device. Subsequently, the identified characteristics are used to create a model on the receiving device and animate the behavior of the sending user. The user model may include all defining features of the sending user's appearance. When applied to any selected avatar, the user model modifies the avatar to better resemble the sending user's appearance. The user model may be stored in a server computer system—hereinafter, a “server” (e.g., a cloud-based storage and/or processing system). Upon initiation of a communication between the source device and the receiving device, data representing the model avatar may be transmitted from the server to the receiving device.

In an alternative embodiment, the sending user's identification operation may be performed in parallel with the tracking operation. In other words, while the sending user's identification operation is being performed, the source device communicates the tracking data to the receiving device. In such an embodiment, the source device starts with prioritizing the sending user's important features. For example, the features may be categorized into a plurality of groups, where the groups may be ordered from the most descriptive features to the least descriptive features. The first group may include the most necessary features in identifying the sending user. For example, the necessary features may be the most descriptive features of the sending user. As another example, the necessary features are what distinguishes one user from another. For example, the necessary features may be more unique to the sending user. The last group may include the least descriptive features.

In an embodiment, the prioritization step is done automatically by the source device. The source device determines the important features and then categorizes them accordingly. In another embodiment, the priorities are communicated by the users to the source device. In yet another embodiment, the prioritization may be performed by a receiving device and then communicated to the source device.

In an embodiment, the more important features may guide the search for identifying the least important features. For example, the features of eyes, nose, and mouth may play a more important role in identifying and tracking the sending user's expressions than the chin, cheek, and eyebrow midpoint. As such, in an embodiment, initially a lower resolution model is formed based on the information associated with the higher priority groups (i.e. the more important features of the sending user). As the communication continues, the model is gradually developed further with additional details of the remaining features.

Whether the sending user's model is developed in advance of a communication session or in parallel, in order to create a model the video analysis unit may identify facial landmarks of the sending user, identify their physical characteristics (e.g. size, shape, and position), and measure the relative distance and angle between those different components. Upon applying the user model to the selected avatar (either on the source device or the receiving device), the avatar is customized to resemble the characteristics of the sending user. Subsequently, the receiving device may only need the avatar data to manipulate the avatar in order to track sending user's motions and expressions.

In an embodiment, the tracking data may be collected by monitoring motions of particular points of the sending user's face/body. The location of the motion points can be selected based on their representative values. Referring to block 220, multiple motion points have been defined to track the sending user's movement of eyes, lips, eyebrows and cheeks. As an example, motion points around the mouth can help with determining lip movements of the avatar 231 animating the face. Motion points around the eyes can be helpful in determining the sending user's emotion and facial expressions. Similarly, the number of motion points can be selected to best track the motions and expressions of the sending user. For example, the number of motion points could be picked based on the parts of the face/body that most frequently moves. In some embodiments, the number and location of the motion points may be predetermined. In other embodiments, the source device may automatically decide the number and location of the motion points based on the behavioral analysis of the particular sending user.

In an embodiment, each of the motion points 225 of the sending user's image has a corresponding motion point 325 in the selected avatar. Therefore, the movements of the motion points 225 may be emulated by their corresponding motion point 325. In another embodiment, the motion information associated with a plurality of motion points 225 may be bundled together in order to represent a particular feature. For example, the information associated with the four motion points surrounding the left eye could be bundled and transmitted as one data unit. In an embodiment, for each feature, a state number between zero and one (or any other suitable number range) may be used to describe the current state of that feature. For example, interpreting the state number associated with the left eye, the receiving device can determine whether the eyes is open or closed, or if it is open, how wide open it is. Similarly, there may be a state number associated with each of the upper and lower lips, eyebrows, cheeks and etc.

Referring to FIG. 3, the operation of an exemplary data transmission management unit is represented in accordance with the depicted flowchart. At block 301, the data transmission management unit receives avatar data in order to communicate information associated with the sending user's features and physical characteristics to the receiving device in real-time. In an embodiment, the avatar data includes modeling and tracking information. Modeling data is used to create a model of the sending user on the receiving end. Tracking information represents movements and changes associated with a selected group of features.

In an embodiment, at block 302, the avatar data is categorized based on their importance. In context of modeling information, as explained previously, different features of the sending user captured by the video may be grouped together based on the features' importance in generating a descriptive model. Initially, when no model has been formed on the receiving end, some of the modeling information may be prioritized over some of the tracking information. As the user's model is developed on the receiving end, the prioritization may change to allow more of the tracking information be transmitted to the receiving device. In an embodiment, some of the avatar data transmitted to the receiving device could be used both to create a model and provide indications as to movements or expressions of the sending user.

In an embodiment, the tracking information may convey movements and changes associated with the features and characteristics of the sending user. This information facilitates rendering of motions and expression of the sending user on the selected avatar in real time. In yet another embodiment, by performing delta modulation, only the changes in motion and physical characteristics of a subsequent frame need be communicated to the receiving device, thereby reducing the required bandwidth. In such circumstances, the information representing a change from a previous frame is prioritized. For example, when the video footage captures the sending user talking, many of the facial features other than the mouth movements may remain the same for a series of frames. So, in this case, only the quantization factor of the face and small differentials representing the movements of the lips may need be transmitted for each frame. In an embodiment, the source device may transmit only the necessary information associated with a new frame in addition to a subset of information referenced to the previous frames.

In other embodiments, the data corresponding to each frame is independent from the data generated for other frames. In other words, each frame is not directly related to each of the other frames. Therefore, if a frame is dropped, for example, due to a lost connection, the stream can continue without impacting the synchronized audio and avatar streams.

At blocks 303 to 305, the source device determines what level of priority to impose on the transmission of the data. For example, at block 202, the system considers the available bandwidth. If the available bandwidth equates to the current traffic of data then no change may be made. However, if the available bandwidth is not sufficient for the current traffic, at block 3031, the source device may modify its transmission policy such that a subset of that data is sent instead. For example, the transmission policy may be modified to send data with a higher priority. Alternatively, if the source device is not fully utilizing the available bandwidth, the transmission policy may be modified to include data with a lower priority. Thus, this modification in policy could increase the accuracy and quality of the avatar animation.

At block 304, the source device considers whether the sending user's model is available in a storage and accessible to the receiving device. As explained previously, once the user's model is developed, whether through a training session or gradually during a communication session, it could be stored in a memory for subsequent usages. In an embodiment, the user's model is stored in a local memory on the receiving device. In other embodiments, the user's model is stored in a server, such as in remote network storage or cloud storage. The user's model could be identified by the sending user's phone number, user ID, or any other form of identification.

Upon establishing the connection, the user's model is retrieved and applied to the selected avatar. Then, tracking information is rendered on the avatar. As such, at block 3041, the transmission policy of the source device may be modified so that the information that is not necessary for tracking is not sent to the receiving device. Alternatively, if no model is available for the receiving device, the source device may determine to prioritize information necessary to create a model.

At block 305, a change to the configuration of the source device could be requested by the user. As such, at block 3051, the transmission policy is modified to reflect the change in configuration. The change in configuration could be instructed from either the sending device or the receiving device. For instance, the configuration could be modified to present an avatar with a lower resolution. As such, fewer features may be detailed on the avatar. Alternatively, the configuration may require a display of an avatar animation in a higher resolution. In such an embodiment, sending additional modeling information may be required to create a more precise model. In an embodiment, the tracking information may keep track of more feature points to present a more realistic animation.

At block 306, the source device transmit avatar data to the receiving device based on the transmission policy. In an embodiment, the transmission policy of the source device may change multiple times during a communication session. For example, the communication may begin with a video streaming of the sending user but when the conditions are not good for video streaming the system may switch to sending only avatar data and sound stream. In such an embodiment, the avatar data may be rendered based on an image of the sending user. For example, the receiving device could render the facial expressions and movements on an actual image of the sending user based on the received avatar data.

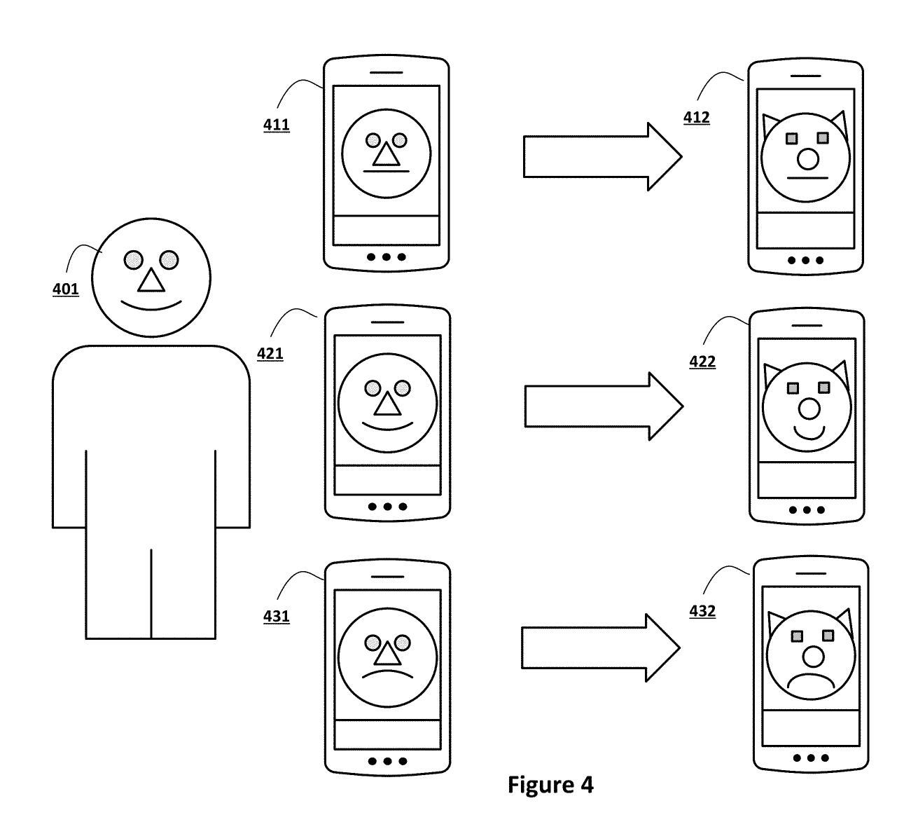

Referring to FIG. 4, the exemplary operation to animate an avatar to mimic the expression and movements of the sending user 401 is illustrated. In an embodiment, the sending user 401 may express different emotions at different points during the video communication. For example, while the capture video 411 of the sending user 401 express no emotion, the captured video 421 and 431 demonstrate a happy and sad expression respectively. In an aspect, the different emotional states of the sending user 401 are demonstrated by his/her facial expressions. In an embodiment, avatar data that tracks the facial features of the sending user 410 is used to determine these facial expressions. As such, the avatar animations 412, 422, and 432 correspond to captured video frames 411, 421, 431 respectively.

In an embodiment, the facial expressions of the sending user 401 may be captured by a series of consecutive frames. The avatar data for each frame includes information associated with each of the selected facial features. In an embodiment, combining information associated with one or more facial features in series of consecutive frame may represent a routine behavioral event, for example, laughing, smiling, nodding, and etc. In an embodiment, rendered animation video of sending user's routine behavioral events may be stored in the receiving device and replayed when the event occurs again.

Referring to FIG. 5, the operation of the receiving device in identifying and storing routine behavioral events is represented in accordance with the depicted flowchart. At block 501, the avatar data is received by the receiving device and rendered on an avatar. In an embodiment, the facial expressions of the sending user may be captured by a series of consecutive frames. The avatar data for each frame includes information associated with each of the selected facial features. In an embodiment, combining information associated with one or more facial features in series of consecutive frame may represent a routine behavioral event, for example, laughing, smiling, nodding, and etc. The avatar data for each frame is applied to the avatar in order to reconstruct an animation of the behavioral event.

At block 502, the receiving device identifies occurrences of a behavioral event. In an embodiment, the identification may be based on a user instruction. In alternative embodiments, the receiving device may automatically detect a behavioral event. For example, the receiving device may recognize receiving similar patterns of avatar data corresponding to one or more facial features. More particularly, in a first group of frames the floating-points corresponding to a particular facial feature may be similar to the floating-points in a second group of frames. Therefore, the receiving device may recognize that a similar behavioral event is occurring in the first and second group of frames. In an embodiment, the receiving device learns the behavior of the sending user over time by storing data representing those behaviors and regularly analyzing the stored information.

At block 503, the receiving device identifies a starting indication for the identified behavioral event. In an embodiment, the receiving device also identifies an ending indication. In another embodiment, a duration from the starting indication is estimated for the behavioral event instead of determining an ending indication. The starting and ending indications mark the beginning and end of the behavioral event respectively. These indications may be based on an avatar data, audio sound, or a user defined input.

In an embodiment, the receiving device may determine that the avatar data associated with one or more consecutive frames corresponds to a beginning of a behavioral event. For example, analysis of avatar data associated with the movements of lips may indicate the beginning of a sending user's smile or laughter. Similarly, the avatar data may also be indicative of an end of the behavioral event. For example, the avatar data illustrative of the lips movement from a laughter position to a normal position may indicate an end to a laughter event.

In other embodiments, the beginning and end of a behavioral event could be marked based on audio sounds corresponding to one or more consecutive frames. For example, occurrences of laughter could be recognized by the sound of laughter. Therefore, by analysis of the audio sounds the system could determine the beginning and end of such behavioral event. In other embodiments, the start and end indications corresponding to a behavioral event may be defined by a user input. The user input could be communicated by any input device include touch-screen, keyboard, microphone, and etc. For example, the user can tap on a touch screen display to send a starting indication to the receiving device indicative of a beginning of a predetermined behavioral event.

At block 504, the information associated with an identified behavioral event is stored. In an embodiment, the stored information may be the avatar data associated with a sequence of frames that generate the particular behavioral event. In other embodiments, the animation video emulating the sending user's action during the event may be stored. In an embodiment, the information may be stored locally on the receiving device memory. Alternatively, the information could also be stored in a server accessible by the receiving device. In an embodiment, upon receiving an indication of occurrence of a particular behavioral event, the receiving device may choose to render the corresponding animation video based on the stored information instead of the transmitted avatar data.

Referring to FIG. 6, the operation of the receiving device in displaying the animated avatar is represented in accordance with the depicted flowchart. At block 601, data associated with the video communication is received by the receiving device. Data may include a video stream, an audio stream, and avatar data. For each frame, the avatar data includes information associated feature points from the sending user. For example, the feature points may be facial landmarks, and their associated information may describe their physical characteristics and keep track of their movements and changes.

At block 602, the transmitted data is processed by the receiving device. The processing may begin with decryption of the files. Then, the audio file is synchronized with avatar data and/or video stream. The processing of the avatar data may include generating a user model based on the information regarding the physical characteristics of the sending user. Such data may be used to customize the selected avatar in order to better resemble the appearances of the sending user. In an embodiment, the receiving device may initially prioritize sending the type of data required to generate a user model. In an embodiment, the receiving device may communicate with the source device as to the type of data it requires at each point in order to influence the source device's transmission policy.

At block 603, the avatar data is rendered in order to display an animation video of the sending user's avatar in real-time. The avatar data includes modeling information and tracking information. In an embodiment, the display avatar is customized based on the modeling information characterizing the sending user's appearance. In other embodiments, as avatar data is transmitted to the receiving device in a communication session, the displayed avatar is gradually customized to better resemble the ending user's features. In an embodiment, the tracking information communicates the current state of feature points of the sending user. Using the tracking information, the receiving device can emulate the movements and changes of the sending user on the selected avatar.

At block 604, the source device monitors the received information to identify event indications. Event indications mark the beginning of routine behavioral events by the sending user. In an embodiment, the event indications could be based on the avatar data, audio sound, and/or predetermined user input. Each event indication is associated with previously stored patterns of behavior by the sending user. The information may be in a video format or avatar data.

Upon detecting an event indication at block 605, at block 606, the information associated with the detected event indication is retrieved. This information may correspond to the one or more subsequent frames. For example, the information may be tracking information regarding the next several frames to recreate the indicated behavioral event (e.g. nodding). Alternatively, the source device may have stored an animation video of the behavioral event and may replay the video upon detection of the corresponding event indication. The animation video may be in format of a video loop (e.g., a GIF).

At block 607, the stored information regarding the behavioral event is used to render an animation video on the receiving device. In an embodiment, the rendering of the animation video is based on the stored avatar data. For example, the receiving device may store the tracking information required to emulate the sending user's laughter by the avatar. This information may be associated with one or more video frames. Therefore, using the stored information, the laughter may be emulated without the need to receive additional avatar data.

At block 608, the receiving device determines when to end the display of the behavioral event. In an embodiment, each stored behavioral information may be associated with an ending indication. Upon detecting occurrences of the ending indication on the sending side, the display of the behavioral event may be terminated on the receiving side. In an embodiment, the display of the behavioral event may continue for a predetermined time period. The time period may be determined by measuring the duration of previously occurred similar behavioral events.

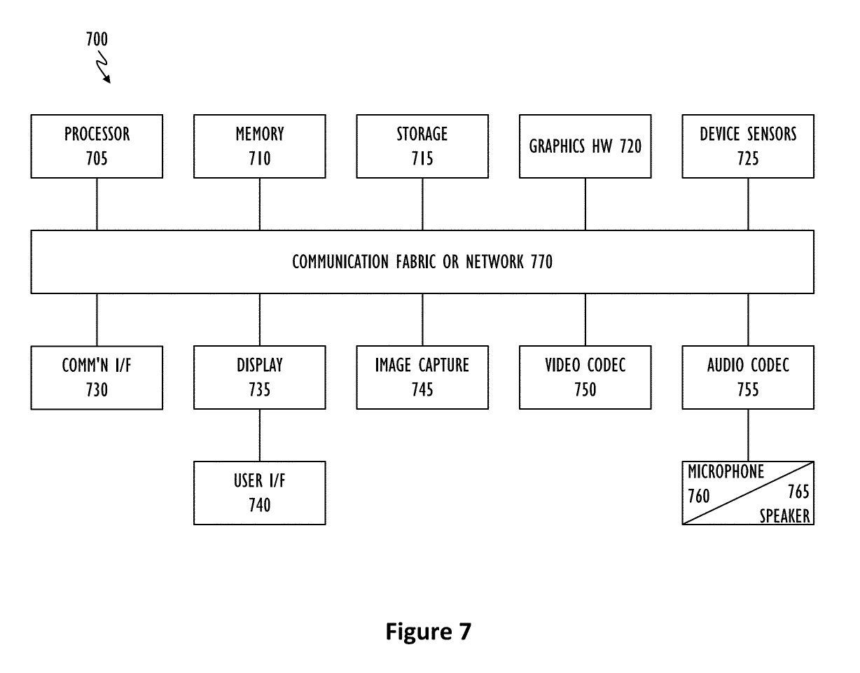

Referring to FIG. 7, a simplified functional block diagram of illustrative electronic device 700 capable of performing the disclosed video communication is shown according to one or more embodiments. Electronic device 700 could be, for example, a mobile telephone, personal media device or a tablet computer system. As shown, electronic device 700 may include processor element or module 705, memory 710, one or more storage devices 715, graphics hardware 720, device sensors 725, communication interface 730, display element 735 and associated user interface 740 (e.g., for touch surface capability), image capture circuit or unit 745, one or more video codecs 750, one or more audio codecs 755, microphone 760 and one or more speakers 765—all of which may be coupled via system bus, backplane, fabric or network 770 which may be comprised of one or more switches or continuous (as shown) or discontinuous communication links.

Processor module 705 may include one or more processing units each of which may include at least one central processing unit (CPU) and zero or more graphics processing units (GPUs); each of which in turn may include one or more processing cores. Each processing unit may be based on reduced instruction-set computer (RISC) or complex instruction-set computer (CISC) architectures or any other suitable architecture. Processor module 705 may be a single processor element, a system-on-chip, an encapsulated collection of integrated circuits (ICs), or a collection of ICs affixed to one or more substrates. Memory 710 may include one or more different types of media (typically solid-state). For example, memory 710 may include memory cache, read-only memory (ROM), and/or random access memory (RAM). Storage 715 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 710 and storage 715 may be used to retain media (e.g., audio, image and video files), preference information, device profile information, computer program instructions or code organized into one or more modules and written in any desired computer programming language, and any other suitable data. When executed by, for example, processor module 705 and/or graphics hardware 720 such computer program code may implement one or more of the video communication operations described herein. Graphics hardware 720 may be special purpose computational hardware for processing graphics and/or assisting processor module 705 perform computational tasks. In one embodiment, graphics hardware 720 may include one or more GPUs, and/or one or more programmable GPUs and each such unit may include one or more processing cores. In another embodiment, graphics hardware 720 may include one or more custom designed graphics engines or pipelines. Such engines or pipelines may be driven, at least in part, through software or firmware. Device sensors 725 may include, but need not be limited to, an optical activity sensor, an optical sensor array, an accelerometer, a sound sensor, a barometric sensor, a proximity sensor, an ambient light sensor, a vibration sensor, a gyroscopic sensor, a compass, a barometer, a magnetometer, a thermistor, an electrostatic sensor, a temperature or heat sensor, a pixel array and a momentum sensor. Communication interface 730 may be used by electronic device 700 to connect to or communicate with one or more networks or other devices. Illustrative networks include, but are not limited to, a local network such as a Universal Serial Bus (USB) network, an organization's local area network (LAN), and a wide area network (WAN) such as the Internet. Communication interface 730 may use any suitable technology (e.g., wired or wireless) and protocol (e.g., Transmission Control Protocol (TCP), Internet Protocol (IP), User Datagram Protocol (UDP), Internet Control Message Protocol (ICMP), Hypertext Transfer Protocol (HTTP), Post Office Protocol (POP), File Transfer Protocol (FTP), and Internet Message Access Protocol (IMAP)). Display element 735 may be used to display text and graphic output as well as receiving user input via user interface 740. For example, display element 735 may be a touch-sensitive display screen. User interface 740 can also take a variety of forms such as a button, keypad, dial, a click wheel, and keyboard. Image capture circuit or module 745 may capture still and video images. By way of example, application and system Us in accordance with this disclosure (e.g., application display in block 230 of FIG. 2), may be presented to a user via display 735, and a user's may be made via user interface 740. Output from image capture unit 745 may be processed, at least in part, by video codec 750 and/or processor module 705 and/or graphics hardware 720, and/or a dedicated image processing unit incorporated within image capture unit 745. Images so captured may be stored in memory 710 and/or storage 715. Audio signals obtained via microphone 760 may be, at least partially, processed by audio codec 755. Data so captured may be stored in memory 710 and/or storage 715 and/or output through speakers 765.

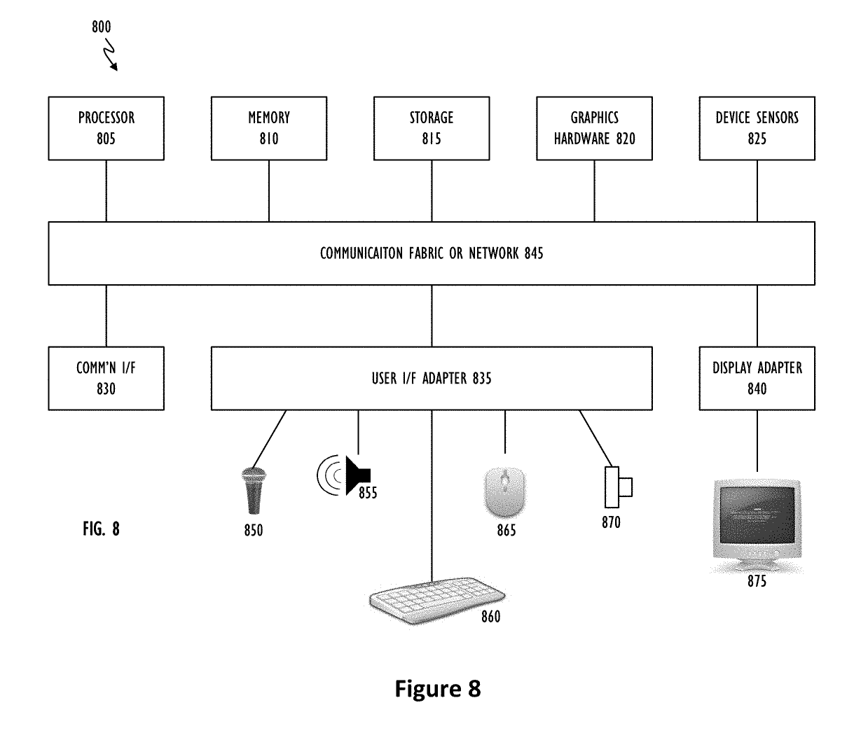

Referring to FIG. 8, the disclosed video communication operations may be performed by representative computer system 800 (e.g., a general purpose computer system such as a desktop, laptop, notebook or tablet computer system). Computer system 800 may include processor element or module 805, memory 810, one or more storage devices 815, graphics hardware element or module 820, device sensors 825, communication interface module or circuit 830, user interface adapter 835 and display adapter 840—all of which may be coupled via system bus, backplane, fabric or network 845 which may be comprised of one or more switches or one or more continuous (as shown) or discontinuous communication links.

Processor module 805 may include one or more processing units each of which may include at least one central processing unit (CPU) and zero or more graphics processing units (GPUs); each of which in turn may include one or more processing cores. Each processing unit may be based on reduced instruction-set computer (RISC) or complex instruction-set computer (CISC) architectures or any other suitable architecture. Processor module 805 may be a single processor element, a system-on-chip, an encapsulated collection of integrated circuits (ICs), or a collection of ICs affixed to one or more substrates. Memory 810 may include one or more different types of media (typically solid-state) used by processor module 805 and graphics hardware 820. For example, memory 810 may include memory cache, read-only memory (ROM), and/or random access memory (RAM). Storage 815 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 810 and storage 815 may be used to retain media (e.g., audio, image and video files), preference information, device profile information, user model, computer program instructions or code organized into one or more modules and written in any desired computer programming language, and any other suitable data. When executed by processor module 805 and/or graphics hardware 820 such computer program code may implement one or more of the methods described herein. Graphics hardware 820 may be special purpose computational hardware for processing graphics and/or assisting processor module 805 perform computational tasks. In one embodiment, graphics hardware 820 may include one or more GPUs, and/or one or more programmable GPUs and each such unit may include one or more processing cores. In another embodiment, graphics hardware 820 may include one or more custom designed graphics engines or pipelines. Such engines or pipelines may be driven, at least in part, through software or firmware. Device sensors 825 may include, but need not be limited to, an optical activity sensor, an optical sensor array, an accelerometer, a sound sensor, a barometric sensor, a proximity sensor, an ambient light sensor, a vibration sensor, a gyroscopic sensor, a compass, a barometer, a magnetometer, a thermistor, an electrostatic sensor, a temperature or heat sensor, a pixel array and a momentum sensor. Communication interface 830 may be used to connect computer system 800 to one or more networks or other devices. Illustrative networks include, but are not limited to, a local network such as a USB network, an organization's local area network, and a wide area network such as the Internet. Communication interface 830 may use any suitable technology (e.g., wired or wireless) and protocol (e.g., Transmission Control Protocol (TCP), Internet Protocol (IP), User Datagram Protocol (UDP), Internet Control Message Protocol (ICMP), Hypertext Transfer Protocol (HTTP), Post Office Protocol (POP), File Transfer Protocol (FTP), and Internet Message Access Protocol (IMAP)). User interface adapter 835 may be used to connect microphone 850, speaker 855, keyboard 860, pointer device 865, and other user interface devices such as image capture device 870 or a touch-pad (not shown). Display adapter 840 may be used to connect one or more display units 875 which may provide touch input capability.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method of an online video communication, comprising:
establishing, by a source device, an online video communication with a receiving device to capture a live recording of a sending user;
analyzing the live recording to identify one or more physical characteristics of the sending user;
generating avatar data corresponding to the identified one or more physical characteristics of the sending user;
categorizing the avatar data into at least two groups, wherein a first group of the at least two groups comprises avatar data that is more unique to the sending; and
transmitting at least the first group of the at least two groups of avatar data to the receiving device based on a transmission policy, wherein the transmitted first group of avatar data defines, at least in part, how to animate an avatar that mimics the sending user's one or more physical characteristics.

2. The method of claim 1, wherein the transmission policy is based on at least one of an available bandwidth for the online communication with the receiving device, user configurations, an availability of avatar data in a local storage, and an availability of avatar data in a cloud storage.

3. The method of claim 2, further comprising:
transmitting at least the first group and the second group of the at least two groups of avatar data to the receiving device when the available bandwidth exceeds a threshold.

4. The method of claim 1, wherein the avatar data comprises modeling information to customize an appearance of the avatar to resemble the sending user's one or more characteristics.

5. The method of claim 4, wherein the avatar data comprises data associated with one or more facial features of the sending user.

6. The method of claim 4, wherein the avatar data comprises tracking information to track movements of the sending user.

7. The method of claim 6, wherein the modeling information is prioritized over the tracking information.

8. A method for an online video communication comprising:
establishing an online video communication with a source device;
receiving avatar data corresponding to one or more facial features of a sending user, wherein the avatar data comprises modeling information;
generating a user model based on the modeling information, the modeling information describing the facial features of the sending user;
receiving a selection of an avatar;
applying the user model to the selected avatar such that the avatar is modified to resemble the facial features of the sending user; and
displaying the modified avatar.

9. The method of claim 8, further comprising:
storing the generated user model of the sending user in a local memory of for subsequence video communications between the sending user and the receiving device; and
associating the user model with a phone number associated with the source device.

10. The method of claim 8, wherein the avatar data comprises tracking information and the method further comprising:
animating the modified avatar based on the tracking information, the tracking information representing the sending user's facial expressions.

11. The method of claim 10, wherein the tracking information describes a state of one or more facial features in a state number between zero and one.

12. The method of claim 8, further comprising:
receiving a starting indication from the source device, wherein the starting indication marks the beginning of a behavioral event;
retrieving information associated with the behavioral event; and
animating the modified avatar based on the retrieved information.

13. The method of claim 11, wherein the information associated with the behavioral event is stored at least in one of a server and a local storage of the receiving device.

14. A device, comprising:
a memory;
a display; and
a processor operatively coupled to the memory and the display and configured to execute program code stored in the memory to:
establish, by a source device, an online video communication with a receiving device to capture a live recording of a sending user;
analyze the live recording to identify one or more physical characteristics of the sending user;
generate avatar data corresponding to the identified one or more physical characteristics of the sending user;
categorize the avatar data into at least two groups, wherein a first group of the at least two groups comprises avatar data that is more unique to the sending user; and
transmit at least the first group of the at least two groups of avatar data to the receiving device based on a transmission policy, wherein the transmitted first group of avatar data is used to animate an avatar on the receiving device that mimics the sending user's one or more characteristics.

15. The device of claim 14, wherein the transmission policy is based on at least one of an available bandwidth for the online communication with the receiving device, user configurations, an availability of avatar data in a local storage, and an availability of avatar data in a cloud storage.

16. The device of claim 14, wherein the avatar data comprises modeling information to customize an appearance of the avatar to better resemble the sending user's one or more characteristics.

17. The device of claim 14, wherein the modeling information comprises data associated with one or more facial features of the sending user.

18. A device, comprising:
a memory;
a display; and
a processor operatively coupled to the memory and the display and configured to execute program code stored in the memory to:
establish an online video communication with a source device;
receive avatar data corresponding to one or more facial features of a sending user, wherein the avatar data comprises modeling information;
generate a user model based on the modeling information, the modeling information describing the facial features of the sending user;
receive a selection of an avatar;
apply the user model to the selected avatar such that the avatar is modified to resemble the facial features of the sending user; and
display the modified avatar.

19. The device of claim 18, further comprising program code to cause the processor to:
store the generated user model of the sending user in a local memory for subsequence video communications between the sending user and the receiving device; and
associating the user model with a phone number associated with the source device.

20. The device of claim 18, further comprising program code to cause the processor to:
receive a starting indication from the source device, wherein the start indication marks the beginning of a behavioral event;
retrieve information associated with the behavioral event; and
animate the modified avatar based on the retrieved information.
